(19) United States
(12) Patent Application Publication
(10) Pub. No.: US 2025/0251946 A1
(43) Pub. Date: Aug. 7, 2025

(54) Pack Framework in an Observability Pipeline System

(71) Applicant: Cribl, Inc., San Francisco, CA (US)

(72) Inventors: Nicholas Robert Romito, Chicago, IL (US); Jan Bieron, Krakow (PL); Nicholas Tankersley, Seattle, WA (US); Sri Kotikelapudi, San Jose, CA (US); Giovianni Mola, San Francisco, CA (US)

(21) Appl. No.: 19/185,858

(22) Filed: Apr. 22, 2025

Related U.S. Application Data
(63) Continuation-in-part of application No. 18/649,141, filed on Apr. 29, 2024.
Application No. 18/649,141 is a continuation of application No. 17/746,527, filed on May 17, 2022, now Pat. No. 12,001,855.

(51) Int. Cl. G06F 9/445; G06F 9/38

(52) U.S. Cl. CPC G06F 9/44505; G06F 9/3867

(57) ABSTRACT

In an observability pipeline system, a worker computer system that is managed by a leader computer system identifies and requests a pack file that is installed at the leader computer system and is not installed at the worker computer system. The pack file is received at the worker computer system. The pack file includes observability pipeline component definitions. The pack file is imported into an observability pipeline system on the worker computer system. Pack components are defined in the observability pipeline system based on the observability pipeline component definitions from the pack file. Pack local configuration settings are defined for the pack components. The pack components are applied to pipeline data in the observability pipeline system.

### CROSS-REFERENCE TO RELATED APPLICATION(S)

This application is a continuation-in-part of U.S. patent application Ser. No. 18/649,141, filed on Apr. 29, 2024, which is a continuation of U.S. patent application Ser. No. 17/746,527, filed on May 17, 2022, now U.S. Pat. No. 12,001,855, the contents of which are hereby incorporated by reference in their entireties herein for all purposes.

### TECHNICAL FIELD

This disclosure relates to pack frameworks in an observability pipeline system.

### BACKGROUND

Observability pipelines are used to route and process data in a number of contexts. For example, observability pipelines can provide unified routing of various types of machine data to multiple destinations, while adapting data shapes and controlling data volumes. In some implementations, observability pipelines allow an organization to interrogate machine data from its environment without knowing in advance the questions that will be asked. Observability pipelines may also provide monitoring and alerting functions, which allow systematic observation of data for known conditions that require specific action or attention.

### SUMMARY

A first aspect of the disclosure is a non-transitory computer-readable storage medium storing instructions operable to cause one or more processors to perform operations. The operations include identifying, at a worker computer system managed by a leader computer system, a pack file installed at the leader computer system and not installed at the worker computer system. The operations also include requesting, at the worker computer system, the pack file. The operations further include receiving, at the worker computer system, the pack file, wherein the pack file includes observability pipeline component definitions. The operations also include importing the pack file into an observability pipeline system on the worker computer system. The operations further include defining pack components in the observability pipeline system based on the observability pipeline component definitions from the pack file. The operations also include defining pack local configuration settings for the pack components. The operations further include applying the pack components to pipeline data in the observability pipeline system.

In some implementations of the non-transitory computer-readable storage medium of the first aspect of the disclosure, the pack file is received from a pack dispensary that is configured to provide copies of the pack file to a first worker group that includes the worker computer system and is also configured to provide copies of the pack file to a second worker group that does not include the worker computer system.

In some implementations of the non-transitory computer-readable storage medium of the first aspect of the disclosure, the worker computer system includes a reference to an installed copy of the pack file at the leader computer system.

In some implementations of the non-transitory computer-readable storage medium of the first aspect of the disclosure, the pack file is defined in part by a dependency on a referenced pack file, and the referenced pack file includes at least one of the observability pipeline component definitions.

In some implementations of the non-transitory computer-readable storage medium of the first aspect of the disclosure, the operations further include transmitting information describing the worker computer system to the leader computer system, wherein receiving the pack file occurs subsequent to transmitting the information describing the worker computer system to the leader computer system, and the pack file is selected by the leader computer system for transmission to the worker computer system based in part on the information describing the worker computer system. In some implementations of the non-transitory computer-readable storage medium of the first aspect of the disclosure, the information describing the worker computer system includes at least one of an application type, a machine type, or an operating system identifier.

In some implementations of the non-transitory computer-readable storage medium of the first aspect of the disclosure, the pack file further includes pack configuration definitions, the worker computer system obtains a leader configuration from the leader computer system, and the pack local configuration settings are defined based on the pack configuration definitions and the leader configuration.

In some implementations of the non-transitory computer-readable storage medium of the first aspect of the disclosure, the pack components include at least one of a processor component configured to accept the pipeline data and apply a transformation to the pipeline data, a source component configured to define a source connection to a source that provides at least a portion of the pipeline data, a sink component configured to define a destination connection to a destination that accepts at least a portion of the pipeline data, a solution component that contains two or more other sub-components in a self-contained system, a knowledge component that contains knowledge objects, a dashboard component, or a system-wide settings component.

A second aspect of the disclosure is a non-transitory computer-readable storage medium storing instructions operable to cause one or more processors to perform operations. The operations include requesting, at a worker computer system managed by a leader computer system, a pack file based on a reference at the worker computer system to an installed copy of the pack file at the leader computer system. The operations also include receiving, at the worker computer system, the pack file, wherein the pack file includes observability pipeline component definitions. The operations further include importing the pack file into an observability pipeline system on the worker computer system. The operations also include defining pack components in the observability pipeline system based on the observability pipeline component definitions from the pack file. The operations further include defining pack local configuration settings for the pack components. The operations also include applying the pack components to pipeline data in the observability pipeline system.

In some implementations of the non-transitory computer-readable storage medium of the second aspect of the disclosure, the pack file is received from a pack dispensary that is configured to provide copies of the pack file to a first worker group that includes the worker computer system and is also configured to provide copies of the pack file to a second worker group that does not include the worker computer system.

In some implementations of the non-transitory computer-readable storage medium of the second aspect of the disclosure, the pack file is defined in part by a dependency on a referenced pack file, and the referenced pack file includes at least one of the observability pipeline component definitions.

In some implementations of the non-transitory computer-readable storage medium of the second aspect of the disclosure, the operations further include transmitting information describing the worker computer system to the leader computer system, wherein receiving the pack file at the worker computer system occurs subsequent to transmitting the information describing the worker computer system to the leader computer system, and the pack file is selected by the leader computer system for transmission to the worker computer system based in part on the information describing the worker computer system. In some implementations of the non-transitory computer-readable storage medium of the second aspect of the disclosure, the information describing the worker computer system includes at least one of an application type, a machine type, or an operating system identifier.

In some implementations of the non-transitory computer-readable storage medium of the second aspect of the disclosure, the pack file further includes pack configuration definitions, the worker computer system obtains a leader configuration from the leader computer system, and the pack local configuration settings are defined based on the pack configuration definitions and the leader configuration.

In some implementations of the non-transitory computer-readable storage medium of the second aspect of the disclosure, the pack components include at least one of a processor component configured to accept the pipeline data and apply a transformation to the pipeline data, a source component configured to define a source connection to a source that provides at least a portion of the pipeline data, a sink component configured to define a destination connection to a destination that accepts at least a portion of the pipeline data, a solution component that contains two or more other sub-components in a self-contained system, a knowledge component that contains knowledge objects, a dashboard component, or a system-wide settings component.

A third aspect of the disclosure is a non-transitory computer-readable storage medium storing instructions operable to cause one or more processors to perform operations. The operations include requesting, at a worker computer system managed by a leader computer system, a pack file. The operations also include receiving, at the worker computer system, the pack file, wherein the pack file includes pack configuration definitions and observability pipeline component definitions. The operations further include importing the pack file into an observability pipeline system on the worker computer system. The operations also include defining pack components in the observability pipeline system based on the observability pipeline component definitions from the pack file. The operations further include defining pack local configuration settings for the pack components based on the pack configuration definitions, wherein the pack local configuration settings include fixed pack configuration settings and changeable pack configuration settings. The operations also include modifying at least one of the changeable pack configuration settings based on a local override value obtained at the worker computer system. The operations further include applying the pack components to pipeline data in the observability pipeline system.

In some implementations of the non-transitory computer-readable storage medium of the third aspect of the disclosure, the pack file is received from a pack dispensary that is configured to provide copies of the pack file to a first worker group that includes the worker computer system and is also configured to provide copies of the pack file to a second worker group that does not include the worker computer system.

In some implementations of the non-transitory computer-readable storage medium of the third aspect of the disclosure, the operations further include transmitting information describing the worker computer system to the leader computer system, wherein receiving the pack file occurs subsequent to transmitting the information describing the worker computer system to the leader computer system, and the pack file is selected by the leader computer system for transmission to the worker computer system based in part on the information describing the worker computer system.

In some implementations of the non-transitory computer-readable storage medium of the third aspect of the disclosure, the information describing the worker computer system includes at least one of an application type, a machine type, or an operating system identifier.

In some implementations of the non-transitory computer-readable storage medium of the third aspect of the disclosure, the pack components include at least one of a processor component configured to accept the pipeline data and apply a transformation to the pipeline data, a source component configured to define a source connection to a source that provides at least a portion of the pipeline data, a sink component configured to define a destination connection to a destination that accepts at least a portion of the pipeline data, a solution component that contains two or more other sub-components in a self-contained system, a knowledge component that contains knowledge objects, a dashboard component, or a system-wide settings component.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram showing aspects of an example computing environment that includes an observability pipeline system.

FIG. 2 is a block diagram showing aspects of an example observability pipeline system deployed in a worker role.

FIG. 3A is a block diagram showing aspects of an example stream data processing engine in the example observability pipeline system in FIG. 2.

FIG. 3B is a block diagram showing a pack data processing engine in the example stream data processing engine shown in FIG. 2.

FIG. 4 is a flow diagram showing an example process of operating a pack data processing engine.

FIG. 5 is a block diagram showing an example computer system.

FIG. 6 is a block diagram of a configuration management system.

FIG. 7 is a block diagram of a pack file.

FIG. 8 is a block diagram of importing the pack file at a worker computer system.

FIG. 9 is a flow diagram showing an example of a process for configuration management in an observability pipeline system.

### DETAILED DESCRIPTION

In some aspects of what is described here, a data processing engine of an observability pipeline system includes one or more pack data processing engines. In some examples, each pack data processing engine includes routes, pipelines, data samples, and knowledge objects, and can be configured according to pack default configuration settings. In some instances, a pack data processing engine can be created and shared between computer systems within the same worker group or distinct worker groups. A pack data processing engine can be imported in an observability pipeline system of a computer system and then applied to process pipeline input data received from a data source. Applying the pack data processing engine to the pipeline input data generates pipeline output data, which can then be delivered to a data destination. Pack data processing engines can be managed by administrators or users, and they can be deployed in observability pipeline systems across one or more organizations or enterprises.

In some implementations, the systems and techniques described here can provide advantages and improvements over conventional technologies. For example, a pack framework deployed in an observability pipeline system can enable users to build and share configuration models, e.g., pack data processing engines, without reconfiguring common use cases, across distributed deployments of an observability pipeline system. In some cases, pack frameworks can provide knowledge that can be used to collect data from more sources and route data to more destinations. In some cases, a pack framework in an observability pipeline system can unlock immediate value for new data sources and groups coming onboard. The built-in knowledge and shareable content available via pack frameworks can reduce the cost, complexity, and time to manage an observability pipeline; can provide flexibility to scale expertise and may accelerate deployments across organization. Accordingly, the system and methods disclosed here may allow quick deployment of proven routes, pipelines, and knowledge objects or leverage common use cases and solutions from other teams. In some cases, a combination of these and potentially other advantages and improvements may be obtained.

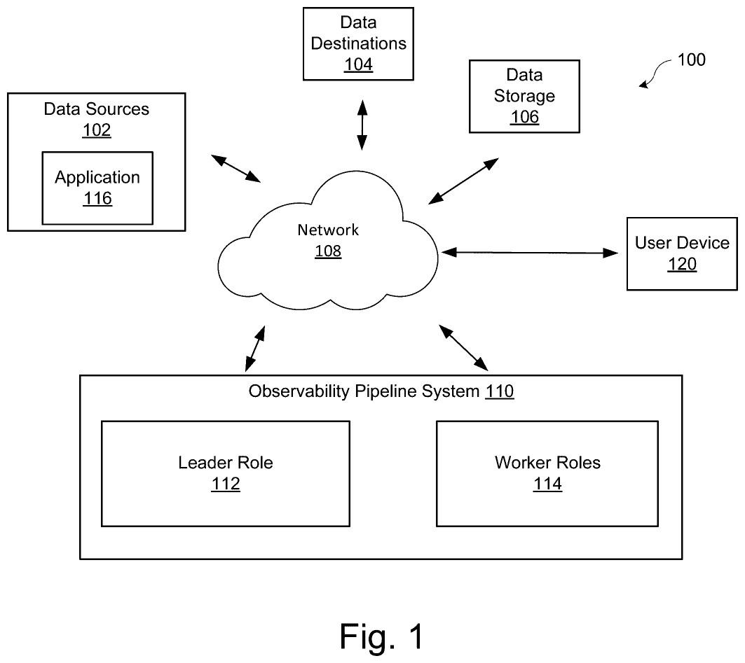

FIG. 1 is a block diagram showing aspects of an example of a computing environment 100 that includes an observability pipeline system 110. In addition to the observability pipeline system 110, the computing environment 100 shown in FIG. 1 includes data sources 102, data destinations 104, data storage 106, a network 108, and a user device 120. The data sources 102 include an application 116. The computing environment 100 may include additional or different features, and the elements of the computing environment 100 may be configured to operate as described with respect to FIG. 1 or in another manner.

In some implementations, the computing environment 100 contains the computing infrastructure of a business enterprise, an organization, or another type of entity or group of entities. During operation, data sources 102 in an organization's computing infrastructure produce volumes of machine data that contain valuable or useful information. The machine data may include data generated by the organization itself, data received from external entities, or a combination. By way of example, the machine data can include network packet data, sensor data, application program data, observability data, and other types of data. Observability data can include, for example, system logs, error logs, stack traces, system performance data, or any other data that provides information about computing infrastructure and applications (e.g., performance data and diagnostic information). The observability pipeline system 110 can receive and process the machine data generated by the data sources 102. For example, the machine data can be processed to diagnose performance problems, monitor user interactions, and to derive other insights about the computing environment 100. Generally, the machine data generated by the data sources 102 does not have a common format or structure, and the observability pipeline system 110 can generate structured output data having a specified form, format, or type. The output generated by the observability pipeline system can be delivered to the data destinations 104, data storage 106, or both. In some cases, the data delivered to the data storage 106 includes the original machine data that was generated by the data sources 102, and the observability pipeline system 110 can later retrieve and process the machine data that was stored on the data storage 106.

In general, the observability pipeline system 110 can provide a number of services for processing and structuring machine data for an enterprise or other organization. In some instances, the observability pipeline system 110 provides schema-agnostic processing, which can include, for example, enriching, aggregating, sampling, suppressing, or dropping fields from nested structures, raw logs, and other types of machine data. The observability pipeline system 110 may also function as a universal adapter for any type of machine data destination. For example, the observability pipeline system 110 may be configured to normalize, de-normalize, and adapt schemas for routing data to multiple destinations. The observability pipeline system 110 may also provide protocol support, allowing enterprises to work with existing data collectors, shippers, and agents, and providing simple protocols for new data collectors. In some cases, the observability pipeline system 110 can test and validate new configurations and reproduce how machine data was processed. The observability pipeline system 110 may also have responsive configurability, including rapid reconfiguration to selectively allow more verbosity with pushdown to data destinations or collectors. The observability pipeline system 110 may also provide reliable delivery (e.g., at least once delivery semantics) to ensure data integrity with optional disk spooling.

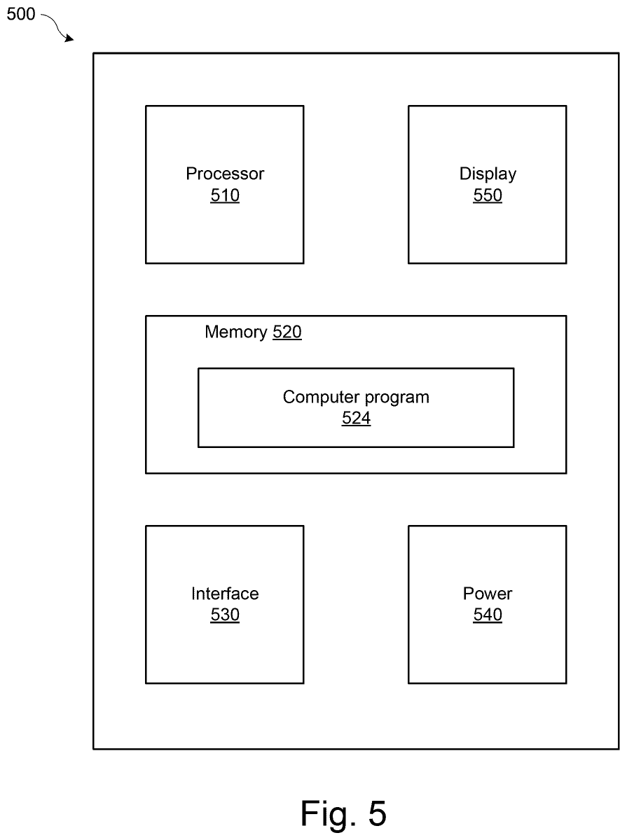

The data sources 102, the data destinations 104, the data storage 106, the observability pipeline system 110, and the user device 120 are each implemented by one or more computer systems that have computational resources (e.g., hardware, software, firmware) that are used to communicate with each other and to perform other operations. For example, each computer system may be implemented as a computer system 500 shown in FIG. 5 or components thereof. In some implementations, computer systems in the computing environment 100 can be implemented in various types of devices, such as, for example, laptops, desktops, workstations, smartphones, tablets, sensors, routers, mobile devices, Internet of Things (IoT) devices, and other types of devices. Aspects of the computing environment 100 can be deployed on private computing resources (e.g., private enterprise servers, etc.), cloud-based computing resources, or a combination thereof. Moreover, the computing environment 100 may include or utilize other types of computing resources, such as, for example, edge computing, fog computing, etc.

The data sources 102, the data destinations 104, the data storage 106, the observability pipeline system 110, the user device 120, and possibly other computer systems or devices communicate with each other over the network 108. The network 108 can include all or part of a data communication network or another type of communication link. For example, the network 108 can include one or more wired or wireless connections, one or more wired or wireless networks, or other communication channels. In some examples, the network 108 includes a Local Area Network (LAN), a Wide Area Network (WAN), a private network, an enterprise network, a Virtual Private Network (VPN), a public network (such as the Internet), a peer-to-peer network, a cellular network, a Wi-Fi network, a Personal Area Network (PAN) (e.g., a Bluetooth low energy (BTLE) network, a ZigBee network, etc.) or other short-range network involving machine-to-machine (M2M) communication, or another type of data communication network.

The data sources 102 can include multiple user devices, servers, sensors, routers, firewalls, switches, virtual machines, containers, or a combination of these and other types of computer devices or computing infrastructure components. The data sources 102 detect, monitor, create, or otherwise produce machine data during their operation. The machine data are provided to the observability pipeline system 110 through the network 108. In some cases, the machine data are streamed to the observability pipeline system 110 as pipeline input data.

The data sources 102 can include data sources designated as push sources (examples include Splunk TCP, Splunk HEC, Syslog, Elasticsearch API, TCP JSON, TCP Raw, HTTP/S, Raw HTTP/S, Kinesis Firehose, SNMP Trap, Metrics, and others), pull sources (examples include Kafkaj, Kinesis Streams, SQS, S3, Google Cloud Pub/Sub, Azure Blob Storage, Azure Event Hubs, Office 365 Services, Office 365 Activity, Office 365 Message Trace, Prometheus, and others), and other types of data sources. The data sources 102 can also include other applications.

In the example shown in FIG. 1, the application 116 includes a collection of computer instructions that constitute a computer program. The computer instructions reside in memory and execute on a processor. The computer instructions can be compiled or interpreted. The application 116 can be contained in a single module or can be statically or dynamically linked with other libraries. The libraries can be provided by the operating system or the application provider. The application 116 can be written in a variety of computer languages, including Java, “C,” “C++,” Python, Pascal, Go, or Fortan as a few examples.

The data destinations 104 can include multiple user devices, servers, databases, analytics systems, data storage systems, or a combination of these and other types of computer systems. The data destinations 104 can include, for example, log analytics platforms, time series databases (TSDBs), distributed tracing systems, security information and event management (SIEM) or user behavior analytics (UBA) systems, and event streaming systems or data lakes (e.g., a system or repository of data stored in its natural/raw format). The pipeline output data produced by the observability pipeline system 110 can be communicated to the data destinations 104 through the network 108.

The data storage 106 can include multiple user devices, servers, databases, or a combination of these and other types of data storage systems. Generally, the data storage 106 can operate as a data source or a data destination (or both) for the observability pipeline system 110. In some examples, the data storage 106 includes a local or remote filesystem location, a network file system (NFS), Amazon S3 buckets, S3-compatible stores, other cloud-based data storage systems, enterprise databases, systems that provides access to data through REST API calls or custom scripts, or a combination of these and other data storage systems. The pipeline output data, which may include the machine data from the data sources 102 as well as data analytics and other output from the observability pipeline system 110, can be communicated to the data storage 106 through the network 108.

The observability pipeline system 110 may be used to monitor, track, and triage events by processing the machine data from the data sources 102. The observability pipeline system 110 can receive an event data stream from each of the data sources 102 and identify the event data stream as pipeline input data to be processed by the observability pipeline system 110. The observability pipeline system 110 generates pipeline output data by applying observability pipeline processes to the pipeline input data and communicates the pipeline output data to the data destinations 104. In some implementations, the observability pipeline system 110 operates as a buffer between the data sources 102 and the data destinations 104, such that all of the data sources 102 send their data to the observability pipeline system 110, which handles filtering and routing the data to proper ones of the data destinations 104.

In some implementations, the observability pipeline system 110 unifies data processing and collection across many types of machine data (e.g., metrics, logs, and traces). The machine data can be processed by the observability pipeline system 110 by enriching it and reducing or eliminating noise and waste. The observability pipeline system 110 may also deliver the processed data to any tool in an enterprise designed to work with observability output data. For example, the observability pipeline system 110 may analyze event data and send analytics to multiple ones of the data destinations 104, thereby enabling the systematic observation of event data for known conditions which require attention or other action. Consequently, the observability pipeline system 110 can decouple data sources from data destinations and provide a buffer that makes many, diverse types of machine data easily consumable.

In some example implementations, the observability pipeline system 110 can operate on any type of machine data generated by the data sources 102 to properly observe, monitor, and secure the running of an enterprise's infrastructure and applications while minimizing overlap, wasted resources, and cost. Specifically, instead of using different tools for processing different types of machine data, the observability pipeline system 110 can unify data collection and processing for all types of machine data (e.g., logs, metrics, and traces) and route the processed machine data to multiple ones of the data destinations 104. Unifying data collection can minimize or reduce redundant agents with duplicate instrumentation and duplicate collection for the multiple destinations. Unifying processing may allow routing of processed machine data to disparate ones of the data destinations 104 while adapting data shapes and controlling data volumes.

In an example, the observability pipeline system 110 obtains DogStatsd metrics, processes the DogStatsd metrics (e.g., by enriching the metrics), sends processed data having high cardinality to a first destination (e.g., Honeycomb) and processed data having low cardinality to a second, different destination (e.g., Datadog). In another example, the observability pipeline system 110 obtains windows event logs, sends full fidelity processed data to a first destination (e.g., an S3 bucket), and sends a subset (e.g., where irrelevant events are removed from the full fidelity processed data) to one or more second, different destinations (e.g., Elastic and Exabeam). In another example, machine data is obtained from a Splunk forwarder and processed (e.g., sampled). The raw processed data may be sent to a first destination (e.g., Splunk). The raw processed data may further be parsed, and structured events may be sent to a second destination (e.g., Snowflake).

The observability pipeline system 110 shown in FIG. 1 includes a leader role 112 and multiple worker roles 114. The leader role 112 leads the overall operation of the observability pipeline system 110 by configuring and monitoring the worker roles 114; the worker roles 114 receive event data streams from the data sources 102 and data storage 106, apply observability pipeline processes to the event data, and deliver pipeline output data to the data destinations 104 and the data storage 106.

The observability pipeline system 110 may deploy the leader role 112 and a number of the worker roles 114 on a single computer node or on many computer nodes. For example, the leader role 112 and one or more of the worker roles 114 may be deployed on the same computer node. Or in some cases, the leader role 112 and each of the worker roles 114 may be deployed on distinct computer nodes. The distinct computer nodes can be, for example, distinct computer devices, virtual machines, containers, processors, or other types of computer nodes.

The user device 120, the observability pipeline system 110, or both, can provide a user interface for the observability pipeline system 110. Aspects of the user interface can be rendered on a display (e.g., the display 550 in FIG. 5) or otherwise presented to a user. The user interface may be generated by an observability pipeline application that interacts with the observability pipeline system 110. The observability pipeline application can be deployed as software that includes application programming interfaces (APIs), graphical user interfaces (GUIs), and other modules.

In some implementations, an observability pipeline application can be deployed as a file, executable code, or another type of machine-readable instructions executed on the user device 120. The observability pipeline application, when executed, may render GUIs for display to a user (e.g., on a touchscreen, a monitor, or other graphical interface device), and the user can interact with the observability pipeline application through the GUIs. Certain functionality of the observability pipeline application may be performed on the user device 120 or may invoke the APIs, which can access functionality of the observability pipeline system 110. The observability pipeline application may be rendered and executed within another application (e.g., as a plugin in a web browser), as a standalone application, or otherwise. In some cases, an observability pipeline application may be deployed as an installed application on a workstation, as an “app” on a tablet or smartphone, as a cloud-based application that accesses functionality running on one or more remote servers, or otherwise.

In some implementations, the observability pipeline system 110 is a standalone computer system that includes only a single computer node. For instance, the observability pipeline system 110 can be deployed on the user device 120 or another computer device in the computing environment 100. For example, the observability pipeline system 110 can be implemented on a laptop or workstation. The standalone computer system can operate as the leader role 112 and the worker roles 114 and may execute an observability pipeline application that provides a user interface as described above. In some cases, the leader role 112 and each of the worker roles 114 are deployed on distinct hardware components (e.g., distinct processors, distinct cores, distinct virtual machines, etc.) within a single computer device. In such cases, the leader role 112 and each of the worker roles 114 can communicate with each other by exchanging signals within the computer device, through a shared memory, or otherwise.

In some implementations, the observability pipeline system 110 is deployed on a distributed computer system that includes multiple computer nodes. For instance, the observability pipeline system 110 can be deployed on a server cluster, on a cloud-based “serverless” computer system, or another type of distributed computer system. The computer nodes in the distributed computer system may include a leader node operating as the leader role 112 and multiple worker nodes operating as respective ones of the worker roles 114. One or more computer nodes of the distributed computer system (e.g., the leader role) may communicate with the user device 120, for example, through an observability pipeline application that provides a user interface as described above. In some cases, the leader role 112 and each of the worker role 114 are distinct computer devices in the computing environment 100. In some cases, the leader role 112 and each of the worker roles 114 can communicate with each other using TCP/IP protocols or other types of network communication protocols transmitted over a network (e.g., the network 108 shown in FIG. 1) or another type of data connection.

In some implementations, the observability pipeline system 110 is implemented by software installed on private enterprise servers, a private enterprise computer device, or other types of enterprise computing infrastructure (e.g., one or more computer systems owned and operated by corporate entities, government agencies, other types of enterprises). In such implementations, some or all of the data sources 102, data destinations 104, data storage 106, and the user device 120 can be or include the enterprise's own computer resources, and the network 108 can be or include a private data connection (e.g., an enterprise network or VPN). In some cases, the observability pipeline system 110 and the user device 120 (and potentially other elements of the computing environment 100) operate behind a common firewall or other network security system.

In some implementations, the observability pipeline system 110 is implemented by software running on a cloud-based computing system that provides a cloud hosting service. For example, the observability pipeline system 110 may be deployed as a SaaS system running on the cloud-based computing system. For example, the cloud-based computing system may operate through Amazon® Web Service (AWS) Cloud, Microsoft Azure Cloud, Google Cloud, DNA Nexus, or another third-party cloud. In such implementations, some or all of the data sources 102, data destinations 104, data storage 106, and the user device 120 can interact with the cloud-based computing system through APIs, and the network 108 can be or include a public data connection (e.g., the Internet). In some cases, the observability pipeline system 110 and the user device 120 (and potentially other elements of the computing environment 100) operate behind different firewalls, and communication between them can be encrypted or otherwise secured by appropriate protocols (e.g., using public key infrastructure or otherwise).

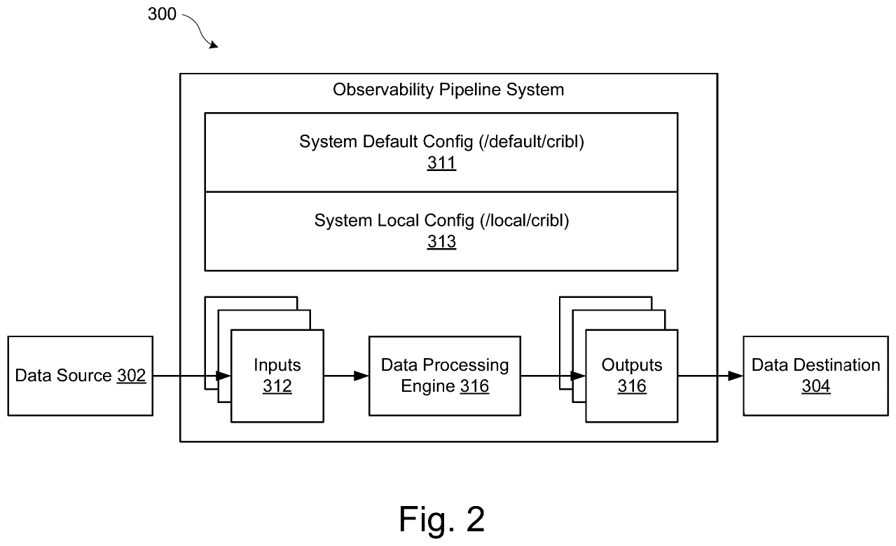

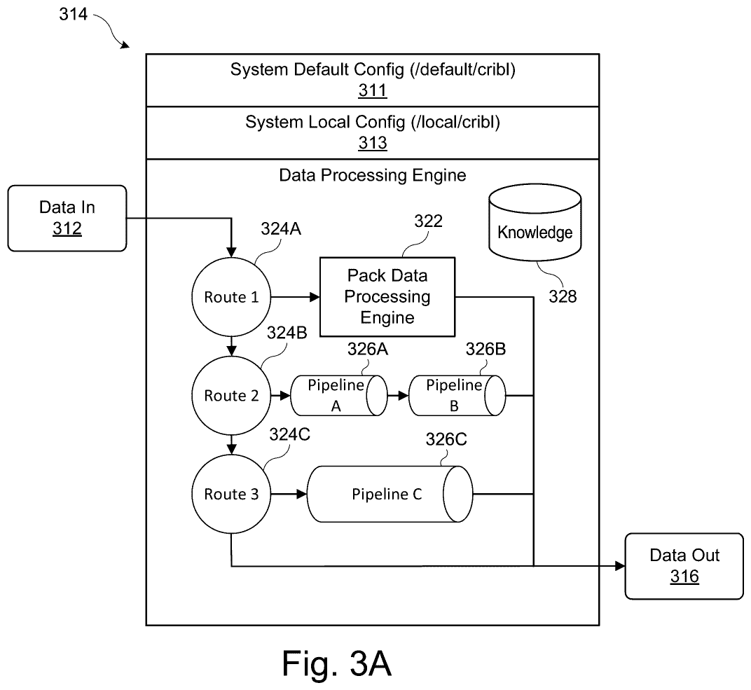

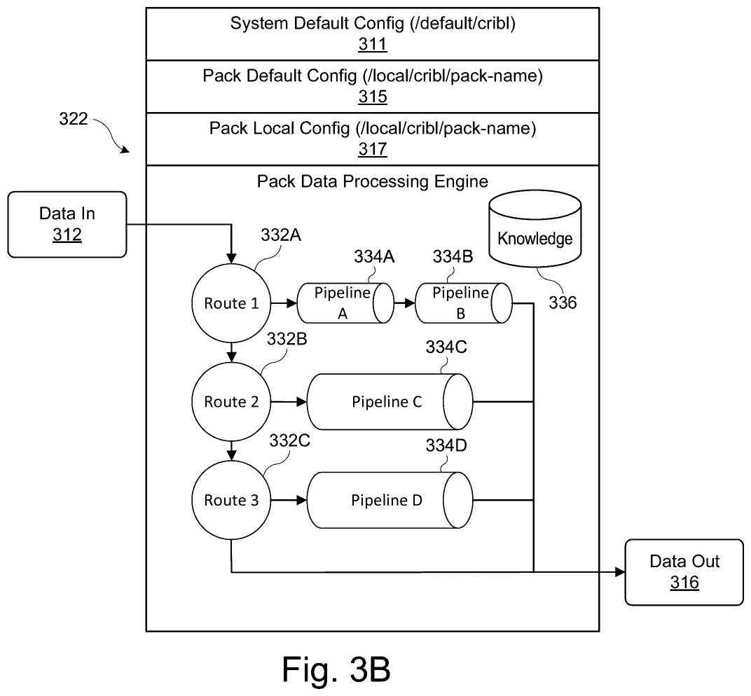

In some implementations, the observability pipeline system 110 includes data processing engines (e.g., the data processing engine 314 in FIGS. 2, 3A). The data processing engines may include one or more pack data processing engines (e.g., the pack data processing engine 322 in FIGS. 3A-3B). A pack framework allows the pack data processing engines to be shared and installed with preconfigured settings. For example, the observability pipeline system 110 can receive and import a pack file that contains routes, pipelines, and knowledge objects, in addition to pack default configuration settings. The observability pipeline system 110 can then define a pack data processing engine that includes the routes, pipelines and potentially other components from the pack file, and the pack data processing engine can be configured according to the pack default configuration settings (provide via the pack file) and pack local configuration settings (e.g., provided locally). The pack data processing engine may then be applied to pipeline input data received from data sources 102 to generate structured output data. In some implementations, the observability pipeline system 110 includes output schemas which can be applied to the structured output data to generate pipeline output data for data destinations 104.

FIGS. 2 and 3A-3B are block diagrams showing aspects of an observability pipeline system 300, an example of a data processing engine 314 in the observability pipeline system 300, and an example of a pack data processing engine 322 in the data processing engine 314. The observability pipeline system 300 is configured to route events or data from one or more data sources, such as data sources 302 to one or more data destinations, such as data destinations 304. Each of the data sources 302 may be implemented in the same manner as the data sources 102 in FIG. 1 or in another manner; and each of the data destinations 304 may be implemented as the data destination 104 in FIG. 1 or in another manner. The observability pipeline system 300 can be operated on a computer system (e.g., the computer system 500 in FIG. 5).

As shown in FIG. 2, the observability pipeline system 300 includes one or more inputs 312, one or more outputs 316, one or more data processing engines, such as a data processing engine 314, system default configuration settings 311, and system local configuration settings 313. The observability pipeline system 300 may include additional or different features, and the components of the observability pipeline system 300 may operate as described with respect to FIG. 2 or in another manner. In some instances, the observability pipeline system 300 can be implemented as the observability pipeline system 110 in FIG. 1 or in another manner.

In some implementations, the observability pipeline system 300 stores pipeline input data from an external data source of the data sources 302 (e.g., Splunk, HTTP, Elastic Beats, Kinesis, Kafka, TCP JSON, etc.) as inputs 312, and the observability pipeline system 300 stores pipeline output data for an external one of the data destinations 304 (e.g., Splunk, Kafka, Kinesis, InfluxDB, Snowflake, Databricks, TCP JSON, etc.) as outputs 316. In certain instances, the external data source of the data sources 302 may be a collector source, a push source, a pull source, a system and internal source, or another type of source; and the external data destination of the data destinations 304 may be a streaming destination, a non-streaming destination, or another type of destination.

As shown in FIG. 2, the data processing engine 314 is applied to pipeline input data (the inputs 312) from the data sources 302, and the data processing engine generates pipeline output data (the outputs 316) that can be delivered to the data destinations 304. The pipeline input data may include logs, metrics, traces, stored data payloads, and possibly other types of machine data. In some cases, some or all of the machine data can be generated by agents (e.g., Fluentd, Collectd, OpenTelemetry) that are deployed at the data sources, for example, on various types of computing devices in a computing environment (e.g., in the computing environment 100 shown in FIG. 1, or another type of computing environment). The logs, metrics, and traces can be decomposed into event data that are consumed by the data processing engine. In some instances, logs can be converted to metrics, metrics can be converted to logs, or other types of data conversion may be applied. Stored data payloads represent event data retrieved from external data storage systems. For instance, stored data payloads can include event data that an observability pipeline process previously provided as output to the external data storage system.

Event data can be streamed to the data processing engine 314 for processing. Here, streaming refers to a continual flow of data, which is distinct from batching or batch processing. With streaming, data are processed as they flow through the system continuously (as opposed to batching, where individual batches are collected and processed as discrete units). In some instances, event data represent events as structured or typed key value pairs that describe something that occurred at a given point in time. For example, the event data can contain information in a data format that stores key-value pairs for an arbitrary number of fields or dimensions, e.g., in JSON format or another format. A structured event can have a timestamp and a “name” field. Instrumentation libraries can automatically add other relevant data like the request endpoint, the user-agent, or the database query. In some implementations, components of the events data are provided in the smallest unit of observability (e.g., for a given event type or computing environment). For instance, the event data can include data elements that provide insight into the performance of the computing environment to monitor, track, and triage incidents (e.g., to diagnose issues, reduce downtime, or achieve other system objectives in a computing environment).

The inputs 312 may include logs that represent events serialized to disk, possibly in several different formats. For example, logs can be strings of text having an associated timestamp and written to a file (often referred to as a flat log file). The logs can include unstructured logs or structured logs (e.g., in JSON format). For instance, log analysis platforms store logs as time series events, and the logs can be decomposed into a stream of event data.

The inputs 312 may include metrics that represent summary information about events, e.g., timers or counters. For example, a metric can have a metric name, a metric value, and a low cardinality set of dimensions. In some implementations, metrics can be aggregated sets of events grouped or collected at regular intervals and stored for low cost and fast retrieval. The metrics are not necessarily discrete and instead represent aggregates of data over a given time span. Types of metric aggregation are diverse (e.g., average, total, minimum, maximum, sum-of-squares) but metrics typically have a timestamp (representing a timespan, not a specific time); a name; one or more numeric values representing some specific aggregated value; and a count of how many events are represented in the aggregate.

The inputs 312 may include traces that represent a series of events with a parent/child relationship. A trace may provide information of an entire user interaction and may be displayed in a Gantt-chart like view. For instance, a trace can be a visualization of events in a computing environment, showing the calling relationship between parent and child events, as well as timing data for each event. In some implementations, individual events that form a trace are called spans. Each span stores a start time, duration, and an identification of a parent event (e.g., indicated in a parent-id field). Spans without an identification of a parent event are rendered as root spans.

The outputs 316 may include data formatted for log analytics platforms, data formatted for time series databases (TSDBs), data formatted for distributed tracing systems, data formatted for security information and event management (SIEM) or user behavior analytics (UBA) systems, and data formatted for event streaming systems or data lakes (e.g., a system or repository of data stored in its natural/raw format). Log analytics platforms are configured to operate on logs to generate statistics (e.g., web, streaming, and mail server statistics) graphically.

TSDBs operate on metrics; example TSDBs include Round Robin Database (RRD), Graphite's Whisper, and OpenTSDB. Tracing systems operate on traces to monitor complex interactions, e.g., interactions in a microservice architecture. SIEMs provide real-time analysis of security alerts generated by applications and network hardware. UBA systems detect insider threats, targeted attacks, and financial fraud. Outputs 316 may be formatted for, and delivered to, other types of data destinations in some cases.

In the example shown in FIG. 2, the data processing engine 314 may includes a schema normalization module that converts the various types of event data to a common schema or representation to execute shared logic across different agents and data types. For example, machine data from various agents such as Splunk, Elastic, Influx, and OpenTelemetry have different, opinionated schemas, and the schema normalization module can convert the event data to normalized event data. Machine data intended for different destinations may need to be processed differently. Accordingly, the data processing engine 314 may include routing modules that routes the normalized event data (e.g., from the schema normalization module) to different processing paths depending on the type or content of the event data. The routing module can be implemented by having different streams or topics. The routing module may route the normalized data to respective functions. The functions can generate structured data from the normalized data; for instance, functions may aggregate, suppress, mask, drop, or reshape the normalized data provided to it by the routing module. The data processing engine 314 may include output schema conversion modules that schematize the structured data provided by the functions. The structured data may be schematized for one or more of the respective ones of the data destinations 304. For instance, the output schema conversion modules may convert the structured data to a schema or representation that is compatible with a data destination.

In some implementations, the system default configuration settings 311 are specified by an entity that owns, manages, or designs the observability pipeline system 300. The system default configuration settings 311 include settings that define properties of the observability pipeline system 300. An example of a system default configuration settings 311 is pipeline timeout; a default config setting for the pipeline timeout can 1000 milliseconds (ms) or another duration of time. In certain instances, the system default configuration settings 311 of the observability pipeline system 300 cannot be modified by a user.

In some instances, the system local configuration settings 313 can be specified, configured, updated, or otherwise modified by a user of the observability pipeline system 300. System local configuration settings 313 include local settings that define properties of the observability pipeline system 300 when being implemented in a local environment. Values of settings in the system local configuration settings 313 may be the same as or different from the values of settings in the system default configuration settings 311. For example, the system local configuration settings 313 may specify a different value for the pipeline timeout, e.g., 900 ms, 2000 ms, or another value, that can be different from the value (e.g., 1000 ms) specified in the system default configuration settings 311.

As shown in FIG. 3A, the data processing engine 314 includes a pack data processing engine 322, the first route 324A, the second route 324B, the third route 324C, the first pipeline 326A, the second pipeline 326B, the third pipeline 326C, and knowledge objects 328. The data processing engine 314 includes a configured set of routes, pipelines, and knowledge objects that convert pipeline input data to pipeline output data. The data processing engine 314 may include additional or different features, and the components of the data processing engine 314 may operate as described with respect to FIG. 3A or in another manner.

In some implementations, a route (e.g., the first route 324A, the second route 324B, or the third route 324C) includes a set of filters which is configured to select a subset of events or data to deliver to respective pipelines and respective destinations. For example, input routes can apply filter expressions on incoming input data to send matching results to one or more respective pipelines. In some instances, filters can include JavaScript-syntax-compatible expressions that are configured with each route 324. In some implementations, each data processing engine 314 includes multiple routes (e.g., the first route 324A, the second route 324B, or the third route 324C) and each of the multiple routes can be associated with one pipeline and one output. Multiple routes may be evaluated in order. In some instances, users may select to make a route non-final which allow the data to match the route (having it sent down the pipeline for that route), get cloned, and sent down the remaining list of routes in order to process the same event multiple times in various ways. For another example, output routes can send data to multiple destinations based on rules. As shown in FIG. 3A, the data processing engine 314 includes a first route 324A, a second route 324B, and a third route 324C.

In some implementations, a pipeline receives events or data matched by a given route 324. In some implementations, pipelines in the data processing engine 314 are processing pipelines. Each pipeline includes a sequence of functions (e.g., built-in or custom) that can process events or data. A function includes codes that execute on an event, and it encapsulates the smallest amount of processing that can happen to that event, for example, string replacement, obfuscation, encryption, event-to-metrics conversions, or another type of processing. In particular, events are delivered to the beginning of a pipeline by a route and processed by the sequence of functions one after another when being passed through the pipeline 326. In some implementations, multiple pipelines can be chained one after another to reuse similar functionality across routes. There can be built-in loop prevention to stop two of the pipelines from referring to each other and causing an infinite loop where data would continuously pass between the same two pipelines and never exit the system. This prevention can be achieved by creating a signature for every pipeline within the observability pipeline system and signing each event that passes through the pipeline.

As shown in FIG. 3A, a first pipeline 326A receives input data from the second route 324B, and output of the first pipeline 326A is sent to a second pipeline 326B; a third pipeline 326C receives input data from the third route 324C; and a pack data processing engine 322 receives input data from the first route 324A. The pack data processing engine 322 is applied to the input data from the first route 324A received from a data source; and structured output data can be generated. In some implementations, the observability pipeline system 300 further includes output schemas conversion modules or other modules or components. In some cases, the output schemas are applied to the structured output data from the pack data processing engine 322; and observability pipeline output data can be generated for a data destination specified by the first route 324A.

In some instances, the data processing engine 314 may include additional or different features, and the components of the data processing engine 314 may operate as described with respect to FIG. 3A or in another manner. For example, the data processing engine 314 may include more routes and each route may include one or more pipelines 326. For another example, output input data from the first route 324A may be processed by one or more pipelines before being received by the pack data processing engine 322.

In some implementations, the knowledge objects 328 include various libraries. For example, the knowledge objects 328 include a Regex Library that contains a set of pre-built common regex patterns, a Grok Patterns Library that contains a set of pre-built common patterns, a lookup library used to enrich events (e.g., for lookup function), a Parsers Library containing Parsers that can be used extract or reserialize events (e.g., for Parser function), a Schema Library that contains Schemas that can be used to validate JSON events, and a Global Variables Library that contains Global Variables that can be accessed by functions in pipelines 326. In some instances, a type of global variables can be number, string, Boolean, object, array, expression, or another type. Knowledge objects 328 can be modular that are referenced within pipelines to allow for reuse of common constructs which instill domain-level knowledge into the data processing engine 314.

In some implementations, the pack default configuration settings 315 defines default properties of the pack data processing engine 322 when the pack data processing engine 322 is initially defined. In some implementations, the pack local configuration settings 317 includes settings that specify properties for the components and processes (e.g., route, pipelines, etc.) in the pack data processing engine 322 when being operated in a specific local environment. The pack local configuration settings 317 are isolated or independent from the system local configuration settings 313. In some implementations, the pack local configuration settings 317 inherit at least one setting of the system default configuration settings 311 and at least one setting of the pack default configuration settings 315. In some instances, the pack local configuration settings 317 can also override at least one setting in the system default configuration settings 311 and at least one of the pack default configuration settings 315. The pack data processing engine 322 has access to all of the default functions and knowledge objects that are available in the data processing engine 314.

The pack data processing engine 322 may include additional or different features, and the components of the pack data processing engine 322 may operate as described with respect to FIG. 3B or in another manner. In some instances, the data processing engine 314 may include more than one pack data processing engine equivalent to the pack data processing engine 322, and the pack data processing engine 322 may be connected with other components of the data processing engine 314 in another manner. For example, a pack data processing engine 322 may receive input data from the first route 324A and output results to one of the outputs 316. In some instances, a pack data processing engine 322 may receive results from or output results to another one of the pipelines 326.

In some instances, the pack data processing engine 322 can be specified when a pipeline is referenced, e.g., when attaching a pre-processing pipeline in a source, when attaching post-processing pipelines in a destination, in routing table's pipeline/output column, etc. In some instances, the pack data processing engine 322 can be accessed according to a deployment type. For example, in a single-instance deployment, the pack data processing engine 322 can be global; in a distributed deployment with a default single worker group (e.g., leader mode) or in a distributed deployment with multiple worker groups, the pack data processing engine 322 can be associated with worker groups and can be shared across different worker groups, e.g., by exporting or importing it as a pack file. In some instances, the pack data processing engine 322 can be upgraded, reconfigured, or otherwise modified.

In some implementations, the pack data processing engine 322 can be created using a computer system within a given worker group (or single-instance deployment). The pack data processing engine 322 that is installed may have a unique pack identification. The pack identification is determined according to the configuration of the pack data processing engine 322. In some instances, the pack data processing engine 322 may also include a pack version and minimum stream version, data type, use cases, technology and other information (e.g., keywords for describing a pack data processing engine 322). Such information is accessible to another user, when the pack data processing engine 322 is exported as a pack file and can be used for users when filtering and search for pack files.

In some instances, a pack data processing engine 322 can be exported as a pack file and shared between users in the same worker group or different worker groups. In some implementations, when a pack data processing engine is exported as a pack file, local modifications made to default configuration settings of the pack data processing engine can be merged into the pack default configuration settings. For example, when an export target is one or more worker groups, the pack default configuration settings 315 and local modifications to the pack default configuration settings (e. g., pack local configuration settings 317) are exported together into a pack file. In some instances, the pack local configuration settings 317 may not be merged into the pack default configuration settings 315 when the pack data processing engine 322 is exported as a pack file. For example, when a local modification to the pack default configuration settings conflicts with the pack default configuration settings, the pack data processing engine 322 can be exported only with the pack default configuration settings 315. In certain instances, a pack data processing engine 322 can be directly exported to one or more worker groups. In some instances, for example in a distributed deployment, multiple pack data processing engines may be exported from one source worker group to one or more destination worker groups.

In some instances, a pack data processing engine 322 in a data processing engine 314 of an observability pipeline system 300 is defined and configured according to a pack file. For example, a pack file can be created by and received from a remote computer system. The pack file can be then imported to a computer system where an observability pipeline system 300 is operated and installed as part of the observability pipeline system. In some instances, a pack file includes routes, pipelines, and pack default configuration settings. The pack file further comprises knowledge objects (e.g., lookup library, Parsers library, Regexes library, Global Variables library, Grok Patterns library, or schemas library) and sample data. In some instances, sources, collectors, and destinations are excluded from a pack file and thus are not specified by a pack file. For example, a route configured in a pack does not need to specify a destination. For another example, a pack file does not need to include event breakers, which are associated with sources.

As shown in FIGS. 2 and 3A-3B, when pipeline input data is received and processed at the observability pipeline system 300 on the computer system, the pipeline input data can be routed to the pack data processing engine 322 in the data processing engine 314 and thus, the pack data processing engine 322 can be applied to the pipeline input data to generate structured output data.

In an implementation, as shown in FIG. 3B, the pack data processing engine 322 includes, a first pack route 332A, a second pack route 332B, and a third pack route 332C that receive the inputs 312. The first pack route 332A is connected to a first pack pipeline 334A, which is connected to a second pack pipeline 334B, which is connected to the outputs 316. The second pack route 332B is connected to a third pack pipeline 334C, which is connected to the outputs 316. The third pack route 332C is connected to a fourth pack pipeline 334D, which is connected to the outputs 316. The pack data processing engine 322 also includes pack knowledge 336.

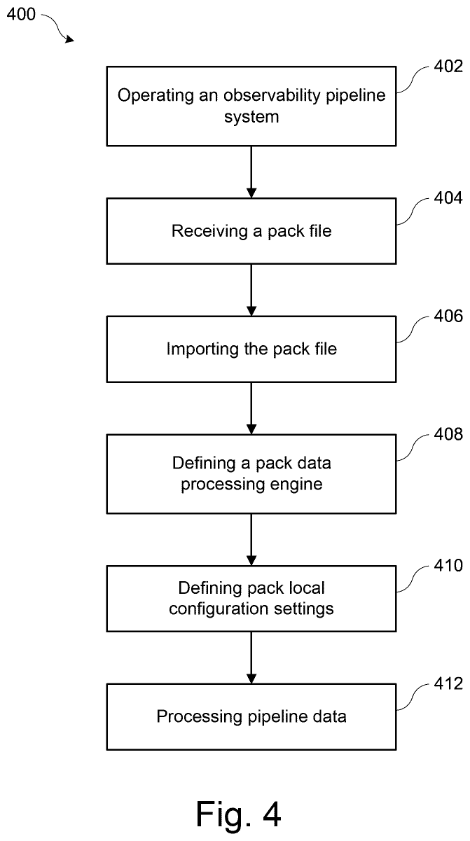

FIG. 4 is a flow diagram showing an example of a process 400 of operating a pack data processing engine. The process 400 can be used for processing pipeline input data in an observability pipeline system. The process 400 may include additional or different operations, including operations to fabricate additional or different components, and the operations may be performed in the order shown or in another order. In some cases, operations in the process 400 can be combined, iterated or otherwise repeated, or performed in another manner.

The operations of the process 400 may be performed on a computer system, for example the observability pipeline system 110 in FIG. 1. The computer system can operate in a computing environment that includes data sources, applications, data destinations, data storage, an observability pipeline system, and a user device. The computing environment may include additional or different features, and the elements of the computing environment may operate as described with respect to FIG. 1 or in another manner. In some cases, the data sources, data destinations, data storage, observability pipeline system, and user device are implemented as the data sources 102, data destinations 104, data storage 106, the observability pipeline system 110, applications 116, and user device 120 shown in FIG. 1, or they may be implemented in another manner.

At 402, the observability pipeline system is operated on the computer system. The observability pipeline system includes data processing engines, system default configuration settings and the system local configuration settings. Each data processing engine is configured according to the system default configuration settings and the system local configuration settings. In operation, the data processing engines process pipeline input data from one or more data sources and provide pipeline output data to one or more data destinations.

At 404, a pack file is received at the computer system. In some instances, the computer system is a leader role in a worker group. In some implementations, a pack file can be received from a trusted or authoritative public or private pack source location, e.g., a dispensary, a file, an URL, Github repository, or another pack source location. In some implementations, a pack file includes pre-configured routes, pipelines, and pack default configuration settings. The pack file may further include knowledge objects (e.g., lookup library, Parsers library, Regexes library, Global Variables library, Grok Patterns library, or schemas library) and sample data.

In some instances, a pack file may include information about a pack data processing engine to be installed on the computer system as part of the observability pipeline system, for example, purpose, compatibility, requirements, and installation of the pack data processing engine. In some instances, a pack file can be received through a URL by the computer system through an internet access (e.g., to the network 108 in FIG. 1), and further distributed to worker nodes within the same worker group through a local network.

At 406, the pack file is imported. In some instances, the pack file can be imported by installing the pack file on the computer system, which becomes part of the observability pipeline system operated on the computer system. In some implementations, multiple pack files can be imported and installed on the computer system. In some cases, multiple pack data processing engines can be defined in the observability pipeline system. Each of the multiple pack files include routes, pipelines, knowledge objects, and respective pack default configuration settings; and each of the pack data processing engines are defined with respective pack local configuration settings. In some cases, a user may manually select a pack file to be imported on the computer system.

At 408, the pack data processing engine is defined in the observability pipeline system according to the pack file. The pack data processing engine can be implemented as the pack data processing engine 322 in the data processing engine 314 of the observability pipeline system 300 in FIGS. 2 and 3A-3B. For example, the pack data processing engine includes routes, pipelines, knowledge objects, and pack default configuration settings, which are included in the pack file. After the pack data processing engine is defined, the computer system may deploy the pack data processing engine in the observability pipeline system, for example by chaining the pack data processing engine with other routes, pipelines and other components or modules in a data processing engine of the observability pipeline system.

At 410, the pack local configuration settings for the pack data processing engine are defined. Once the pack data processing engine is defined in the observability pipeline system, the pack data processing engine can be reconfigured, changed, updated, or otherwise modified for a specific local computing environment. In some implementations, the pack local configuration settings are defined by the user on the computer system for the pack data processing engine 322. The pack local configuration settings 317 are isolated from the system local configuration settings 313. In some implementations, the pack local configuration settings 317 include settings that specify properties for the components and processes (e.g., route, pipelines, etc.) in the pack data processing engine 322 when being operated in a local environment. In some implementations, the pack local configuration settings 317 inherit at least one setting of the system default configuration settings 311 and at least one setting of the pack default configuration settings 315. In some instances, the pack local configuration settings 317 can also override at least one setting in the system default configuration settings 311 and at least one of the pack default configuration settings 315.

At 412, the pipeline input data is received by the observability pipeline system. The pipeline input data may be communicated to the observability pipeline system over a network (e.g., the network 108 shown in FIG. 1) or in another manner. The pipeline input data may be implemented as the pipeline input data (e.g., the inputs 312 of FIG. 2), or other types of observability pipeline data. The pipeline input data may be placed in an in-memory queue. Alternatively, the pipeline input data may be stored to a file. Other methods for storage of the pipeline input data may be used.

In some implementations, at least a subset of the pipeline input data can be routed to the pack data processing engine in the data processing engine; and the pack data processing engine can be applied to the at least a subset of the pipeline input data. Once the at least a subset of the pipeline input data is received at the pack data processing engine, the at least a subset of the pipeline input data can be directed by the routes to respective pipelines of the pack data processing engine, where structured output data can be generated according to the respective pipelines along that route.

When pipeline input data is processed in the observability pipeline system, the input data is received from the data source; structured output data can be generated by applying the pack data processing engine to the pipeline input data; and when output schemas are applied to the structured output data, observability pipeline output data can be generated for the destination.

FIG. 5 is a block diagram showing an example of the computer system 500, which includes a data processing apparatus and one or more computer-readable storage devices. The term “data-processing apparatus” encompasses all kinds of apparatus, devices, nodes, and machines for processing data, including by way of example, a programmable processor, a computer, a system on a chip, or multiple ones, or combinations, of the foregoing, e.g., processor 510. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code), e.g., computer program 524, can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be

performed by one or more programmable processors, e.g., processor 510, executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read-only memory or a random-access memory or both, e.g., memory 520. Elements of a computer can include a processor that performs actions in accordance with instructions, and one or more memory devices that store the instructions and data. A computer may also include or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a phone, an electronic appliance, a mobile audio or video player, a game console, a Global

Positioning System (GPS) receiver, or a portable storage device (e.g., a universal serial bus (USB) flash drive). Devices suitable for storing computer program instructions and data include all forms of non-volatile memory, media, and memory devices, including by way of example, semiconductor memory devices (e.g., EPROM, EEPROM, flash memory devices, and others), magnetic disks (e.g., internal hard disks, removable disks, and others), magneto optical disks, and CD ROM and DVD-ROM disks. In some cases, the processor and the memory can be supplemented by, or incorporated in, special purpose logic circuitry.

The power unit 540 provides power to the other components of the computer system 500. For example, the other components may operate based on electrical power provided by the power unit 540 through a voltage bus or other connection. In some implementations, the power unit 540 includes a battery or a battery system, for example, a rechargeable battery. In some implementations, the power unit 540 includes an adapter (e.g., an AC adapter) that receives an external power signal (from an external source) and converts the external power signal to an internal power signal conditioned for a component of the computer system 500. The power unit 540 may include other components or operate in another manner.

To provide for interaction with a user, operations can be implemented on a computer having a display device, e.g., display 550, (e.g., a monitor, a touchscreen, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to, and receiving documents from, a device that is used by the user; for example, by sending web pages to a web browser on a user's client device in response to requests received from the web browser.

The computer system 500 may include a single computing device, or multiple computers that operate in proximity or generally remote from each other and typically interact through a communication network, e.g., via interface 530. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship between client and server may arise by virtue of computer programs running on the respective computers and having a client-server relationship to each other.

The interface 530 may provide communication with other systems or devices. In some cases, the interface 530 includes a wireless communication interface that provides wireless communication under various wireless protocols, such as, for example, Bluetooth, Wi-Fi, Near Field Communication (NFC), GSM voice calls, SMS, EMS, or MMS messaging, wireless standards (e.g., CDMA, TDMA, PDC, WCDMA, CDMA2000, GPRS) among others. Such communication may occur, for example, through a radio-frequency transceiver or another type of component. In some cases, the interface 530 includes a wired communication interface (e.g., USB, Ethernet) that can be connected to one or more input/output devices, such as, for example, a keyboard, a pointing device, a scanner, or a networking device such as a switch or router, for example, through a network adapter.

In a general aspect, an observability pipeline system includes a pack data processing engine.

In a first example, the observability pipeline system includes data processing engines, system default configuration settings, and system local configuration settings. The data processing engines are configured according to the system default configuration settings and the system local configuration settings. A pack file is received from a remote computer system at the computer system, the pack file comprising routes, pipelines, and pack default configuration settings. The pack file is imported in the observability pipeline system on the computer system. A pack data processing engine is defined in the observability pipeline system. The pack data processing engine includes the routes and pipelines from the pack file. Pack local configuration settings, defined for the pack data processing engine, inherit at least one of the system default configuration settings and at least one of the pack default configuration settings. The pack local configuration settings are isolated from the system local configuration settings. When pipeline data is processed in the observability pipeline system on the computer system, the pack data processing engine is applied to the pipeline data.

Implementations of the first example may include one or more of the following features. The pack local configuration settings override at least one of the system default configuration settings and at least one of the pack default configuration settings. When the pack data processing engine is applied to the pipeline data, input data is routed to the respective pipelines according to the routes; and structured output data is generated from the input data by operation of the pipelines. The plurality of data processing engines includes a first data processing engine including a first route. When the pipeline data is processed in the observability pipeline system, input data is routed to the pack data processing engine according to the first route; and the pack data processing engine is applied to the input data. The first route specifies a source and a destination. When the pipeline data is processed in the observability pipeline system, the input data is received from the source; structured output data is generated by applying the pack data processing engine to the input data; and output schemas are applied to the structured output data to generate observability pipeline output data for the destination. The pack file further includes knowledge objects and sample data.

Implementations of the first example may include one or more of the following features. The pack file is a first pack file; the pack data processing engine is a first pack data processing engine; the pack default configuration settings are first pack default configuration settings; and the pack local configuration settings are first pack local configuration settings. A second pack file is received from another remote computer system at the computer system. The second pack file includes second pack default configuration settings. The second pack file is imported in the observability pipeline system on the computer system. A second pack data processing engine is defined in the observability pipeline system. Second pack local configuration settings are defined for the second pack data processing engine. The second pack local configuration settings inherit at least one of the system default configuration settings and at least one of the second pack default configuration settings. The pack local configuration settings are isolated from the system local configuration settings and the first pack local configuration settings.

In a second example, a computer system includes one or more computer processors that perform one or more operations of the first example.

In a third example, a non-transitory computer-readable medium comprises instructions that are operable when executed by data processing apparatus to perform one or more operations of the first example.

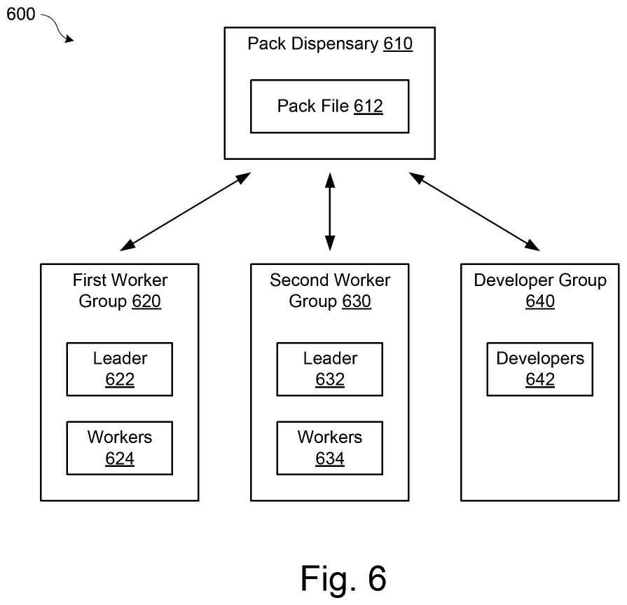

FIG. 6 is a block diagram of a configuration management system 600. The configuration management system 600 includes a pack dispensary 610, a first worker group 620, a second worker group 630, and a developer group 640. The configuration management system 600 may be implemented in the context of the computing environment 100 to support operations of the observability pipeline system 110. Thus, the descriptions of the computing environment 100 and the observability pipeline system 110 are applicable to the configuration management system 600, components of those systems can be included in the configuration management system 600, and aspects of the configuration management system 600 may be implemented in the manner previously described with respect to the computing environment 100 and the observability pipeline system 110.

The pack dispensary 610 is responsible for storing, managing, and distributing pack files, such as a pack file 612, to worker groups, such as the first worker group 620 and the second worker group 630. As will be explained herein, the pack dispensary 610 ensures that the correct versions of pack files are available and properly synchronized across the devices that are managed by the configuration management system, which facilitates efficient deployment of observability pipeline components.

The pack file 612 is a structured data file that contains observability pipeline component definitions, configuration settings, and dependency information that are used to configure computer systems that are associated with the configuration management system 600. The pack file 612 enables system-wide consistency by ensuring that all of the computer systems that are associated with the configuration management system 600 and operate with the same standardized configurations and definitions. The pack file 612 is representative of a large number of pack files that may exist within the configuration management system 600. These pack files are designed to store and manage observability pipeline component definitions, configuration settings, and dependencies. Each pack file can be tailored for specific tasks. The availability of multiple pack files that are implemented in the manner described with respect to the pack file 612 allows for flexible deployment, version control, and scalability across a distributed network of worker computer systems, such as in the computing environment 100.

The first worker group 620 and the second worker group 630 are examples of worker groups that may be associated with and managed by the configuration management system 600. Any number of worker groups may be included in the configuration management system 600, and thus, two or more worker groups may communicate (e.g., using a network) with the pack dispensary 610 to receive the pack file 612. The first worker group 620 and the second worker group 630 each include computer systems that work together in a coordinated manner to perform observability pipeline operations.

The first worker group 620 is managed by a leader computer system, referred to herein as a leader 622. The first worker group 620 also includes one or more worker computer systems, referred to herein as workers 624. Each of the workers 624 from the first worker group 620 is managed by the leader 622. Similarly, the second worker group 630 is managed by a leader computer system, referred to herein as a leader 632. The second worker group 630 also includes one or more worker computer systems, referred to herein as workers 634. Each of the workers 634 from the second worker group 630 is managed by the leader 632.

The leader 622 and the leader 632 are implemented in a similar manner, and the description of the leader 622 is applicable to the leader 632. The leader 622 is a computer system that manages and coordinates the operations of the first worker group 620. The leader 622 is responsible for controlling the configuration of the workers 624. As an example, the leader 622 may be configured in a certain manner using the pack file 612 and/or other pack files obtained from the pack dispensary 610. The configuration of the leader 622 is used as a model to determine the configuration for each of the workers 624, which may be accomplished, for example, by a reference at each of the workers 624 to packs that are installed at 622, or by comparison of the configuration of packs at each of the workers 624 to packs installed at the leader 622.

The workers 624 and the workers 634 are implemented in a similar manner, and the description of the workers 624 is applicable to the workers 634. The workers 624 are computer systems that are configured to implement a data observability pipeline. Each of the workers 624 is configured to process, transform, and manage incoming data streams in accordance with an observability pipeline configuration that is defined by one or more pack files, such as the pack file 612, as will be described. The workers 624 execute tasks such as data collection from various sources, applying transformations or enrichments, and forwarding processed data to designated sinks. The workers 624 operate under the direction of the leader 622, ensuring consistency in data processing and adhering to the system-wide configuration policies established through the pack files. The workers 634 of the second worker group 630 may be equivalent to the workers 624 of the first worker group 620 and may be implemented in the same manner, but with different configurations for the data observability pipeline components thereof.

The workers 624 may be configured in the same way as the leader 622, such as by installation of the same pack files (e.g., including the pack file 612) and through use of some or all of the same configuration settings. Similarly, the workers 634 may be configured in the same way as the leader 632, such as by installation of the same pack files (e.g., including the pack file 612) and through use of some or all of the same configuration settings. However, the leader 622 and the leader 632 may be configured differently, such as through installation of different groups of pack files of through differing configuration settings for the pack files. These differences in pack files and configuration settings allow the first worker group 620 and the second worker group 630 to be configured to perform different functions and workflows by having separately configured data observability pipelines and/or other components.

The developer group 640 includes one or more developer computer systems, referred to herein as developers 642. The developers 642 are responsible for designing, creating, and updating pack files, such as the pack file 612, which is stored in the pack dispensary 610. Newly created or updated pack files, including the pack file 612, are transmitted from the developer group 640 to the pack dispensary 610, where they are stored and made available for distribution to the first worker group 620, the second worker group 630, and other worker groups. Thus, the pack file 612 may be authored and/or modified within a first group, such as the developer group 640, and may subsequently be stored at the pack dispensary 610 for installation and use within a second group, which may be the first worker group 620, the second worker group 630, or another group.

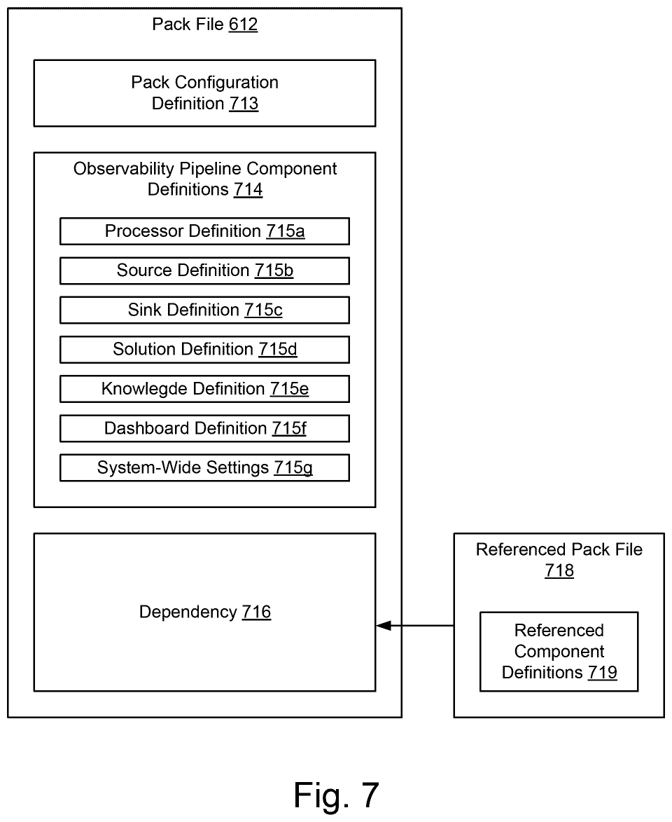

FIG. 7 is a block diagram of the pack file 612. In the illustrated implementation, the pack file 612 includes a pack configuration definition 713 (e.g., one or more pack configuration definitions), observability pipeline component definitions 714 (e.g., one or more observability pipeline component definitions), and a dependency 716 (e.g., one or more dependencies). Fewer components or additional components may be included in the pack file 612.

The pack configuration definition 713 describes settings that are applied during installation of the pack file 612. Some (e.g., one or more) of the settings in the pack configuration definition 713 may be locked settings that cannot be changed or overridden during installation at either of the leader 622 or the workers 624. Some (e.g., one or more) of the settings in the pack configuration definition 713 may be leader-changeable settings that can be changed or overridden during installation at the leader 622 but cannot be changed or overridden during installation at the workers 624. The values for of the leader-changeable settings may then be used for installation at the workers 624 instead of the default values from the pack configuration definition 713. Some (e.g., one or more) of the settings in the pack configuration definition 713 may be changeable settings that can be changed or overridden during installation at either of the leader 622 or the workers 624. As an example, some of the settings from the pack configuration definition 713 may be used as default values in a template or installation wizard, and a user or automated installation script may override the default values during installation at the leader 622 or the workers 624.

The observability pipeline component definitions 714 include information that defines an observability pipeline component and allows it to be installed at a computing system, such as at one of the workers 624 of the first worker group 620. The observability pipeline component definitions 714 specify the structure, configuration, and functional attributes necessary for executing observability pipeline components. The observability pipeline component definitions 714 may include various types of information that define what a particular observability pipeline component is, how it is installed, and how it functions after it is installed. The observability pipeline component definitions 714 may be provided in the form of structured data such as JSON or YML, in the form of executable program instructions, and/or in another suitable form.

The observability pipeline component definitions 714 may include one or more of a processor component definition 715a, a source component definition 715b, a sink component definition 715c, a solution component definition 715d, a knowledge component definition 715e, a dashboard component definition 715f, and a system-wide settings component 715g. Each of these types of definitions is configured to allow a different type of observability pipeline component to be defined during installation of the pack file 612. These are examples of types of component definitions that can be included in the observability pipeline component definitions 714, and additional types of component definitions and/or other information may be included in the observability pipeline component definitions 714 of the pack file 612.

The processor component definition 715a defines a data processing component, such as the data processing engine 314 or the pack data processing engine 322. As an example, a data processing component defined using the processor component definition 715a may accept data from a global stream and may include routes or pipes to modify the data before it is returned to the global stream or to another destination.

The source component definition 715b defines a data source component that data can be obtained from, such as the data sources 102 or the data sources 302. The source component definition 715b may include information that identifies a data source and provides configuration information that allows the data source to be accessed, such as information identifying an API endpoint for a data source. The source component definition 715b may identify multiple sources to allow connection to all of them. The source component definition 715b may further include routes or pipes to modify the data leaving before it leaves the pack component defined by the source component definition 715b. The sink component definition 715c defines a data destination such as the data destinations 104 or the data destinations 304. The sink component definition 715c may include information that identifies a data destination and provides configuration information that allows the data destination to be accessed (e.g., by allowing transmission of data to it). The sink component definition 715c may identify multiple data destinations to allow connection to all of them. The sink component definition 715c may further include routes or pipes to modify the data leaving before it is transmitted to the pack component defined by the sink component definition 715c.

The solution component definition 715d includes information to define a solution component that contains two or more other sub-components in a self-contained system. The sub-components may include, as examples, sources, routes/pipes, and destinations. The solution components that are defined using the solution component definition 715d are configured such that data is fully contained within the solution component. All data processed by the solution component is obtained from sources that it defines, and the processed data is only output to destinations that are defined by the solution component.

The knowledge component definition 715e is configured to define a knowledge component within an installed pack that contains a collection of knowledge objects. Examples of knowledge components include regular expressions and global variables. The dashboard component definition 715f is configured to define, when installed, a dashboard component, which is a user interface that displays information during operation of observability pipeline components and/or allows a user to issue commands or otherwise interact with the observability pipeline components. As an example, the dashboard component definition 715f may define a search dashboard.

The dependency 716 is a reference to another pack file, such as a referenced pack file 718 in the illustrated implementation. The referenced pack file 718 may be stored by the pack dispensary 610 and the dependency 716 includes information that is sufficient to identify the referenced pack file 718 and obtain it from the pack dispensary 610 or from another data storage location. In one implementation, the information contained in the referenced pack file 718 is obtained when the pack file 612 is installed (e.g., by one of the workers 624). In another implementation, the information contained in the referenced pack file 718 is explicitly added to the pack file 612 when the pack file 612 is authored and stored in the pack dispensary 610 (e.g., by one of the developers 642). The referenced pack file 718 may be implemented in the same way as pack file 612. For example, the referenced pack file 718 may include referenced observability pipeline component definitions 719 that are equivalent to the observability pipeline component definitions 714 of the pack file 612.

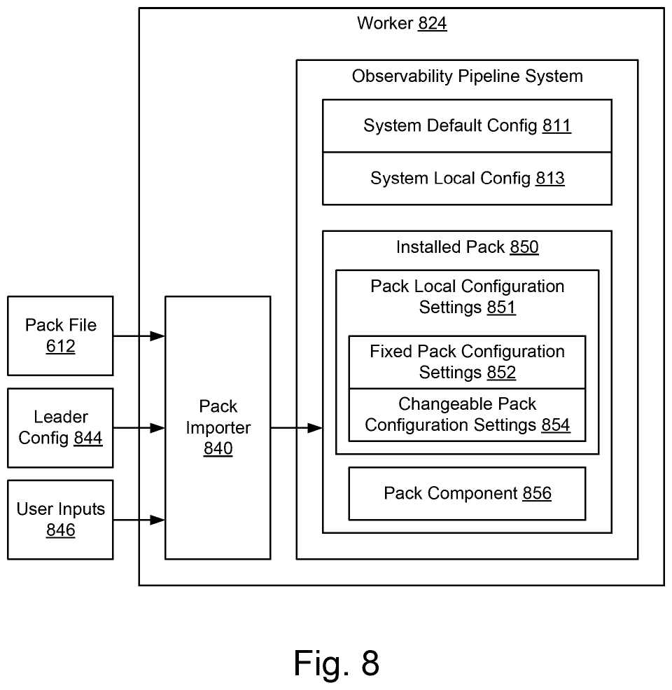

FIG. 8 is a block diagram of importing the pack file 612 at a worker computer system 824. The worker computer system 824 may be one of the workers 624 of the first worker group 620 and is configured as previously described. The worker computer system 824 includes an observability pipeline system 810, which is configured according to the description of the observability pipeline system 300. The system default configuration settings 811 are equivalent to the system default configuration settings 311, and the system local configuration settings 813 are equivalent to the system local configuration settings 313.

The pack importer 840 is component of the worker computer system 824 and functions to install the pack file 612 at the worker computer system 824. The pack importer 840 receives the pack file 612 from the pack dispensary 610 or from another source. The pack file 612 includes default configuration settings that can be used for installation, such as the pack configuration definition 713. These settings are similar to the pack default configuration settings 315 and the description of the pack default configuration settings 315 is relevant except as otherwise described herein.

The pack importer 840 may receive a leader configuration 844 as an input. The leader configuration 844 includes configuration settings that are used by the pack importer 840 during installation and configuration of the pack file 612. The leader configuration 844 may include some or all of the configuration settings from a leader computer system, such as the leader 622, that the worker computer system 824 is managed by. For example, the pack file 612 is also installed at the leader 622, and the leader configuration 844 includes the settings that are used by the leader 622 to operate the pack file 612 at the leader 622. The leader configuration 844 may be used during installation of the pack file 612 to override and replace specific values from the pack configuration definition 713. Thus, for example, if the leader configuration 844 includes a value that differs from the value for the same setting in the default configuration settings, the value from the leader configuration 844 is used during installation of the pack file 612 at the worker computer system 824. In other implementations, the default configuration settings, such as the pack configuration definition 713, are not used during installation and all configuration settings used for installation of the pack file 612 at the worker computer system 824 are obtained from the leader configuration 844.

The pack importer 840 may also receive user inputs 846 during installation of the pack file 612 at the worker computer system 824. As an example, the user inputs 846 may be override values that change some of the configuration settings used during installation of the pack file 612. Thus, the user inputs 846 may change one or more settings from the default configuration settings, such as settings from the pack configuration definition 713 and/or may change one or more settings from the leader configuration 844. Alternatively, the pack file 612 may be imported automatically, without using the user inputs 846.

The pack file 612 may be imported by the pack importer 840 in the manner described with respect to the pack data processing engine 322 and operation 406 of the process 400, and as further described herein. The import process performed by the pack importer 840 defines an installed pack 850 in the observability pipeline system 810 of the worker computer system 824. The installed pack 850 includes pack local configuration settings 851 comprising fixed pack configuration settings 852 and changeable pack configuration settings 854. The installed pack 850 also includes a pack component 856 (e.g., one or more pack components).

The fixed pack configuration settings 852 are settings that cannot be changed at the worker computer system 824 during or after installation and instead are protected from modification at the worker computer system 824. The fixed pack configuration settings 852 at the worker computer system 824 include settings obtained from the pack configuration definition 713 of the pack file 612 and/or from the leader configuration 844, where such settings are locked so that they cannot be changed at the worker computer system 824. The fixed pack configuration settings 852 at the worker computer system 824 may also include one or more settings from the leader configuration 844 that were provided by the leader 622 as overrides for the settings in the pack configuration definition 713 of the pack file 612. In an example, the fixed pack configuration settings 852 may include only settings that are locked and cannot be modified when installed at the worker computer system 824.

The changeable pack configuration settings 854 are settings that change be changed during installation of the pack file 612 during installation at the worker computer system 824 and optionally may be changed subsequent to installation. Thus, the changeable pack configuration settings 854 are not protected against modification at the worker computer system 824. In some implementations, The changeable pack configuration settings 854 are values that are changed based on the user inputs 846 using a template, wizard, or other interface during installation. In some implementations, the changeable pack configuration settings 854 may be values that are changed programmatically during installation, for example, based on a system configuration of the worker computer system 824.

The pack component 856 is an observability pipeline component that is defined at the worker computer system 824 using information from the pack file 612. The pack component 856 may be a single component or a group of one or more components that are installed and configured during installation of the pack file 612 at the worker computer system 824. The pack component 856 is installed and configured using the observability pipeline component definitions 714 that are included in the pack file 612. As examples, the pack component 856 that is installed at the worker computer system 824 may be one or more of a processor component, a source component, a sink component, a solution component, a knowledge component, a dashboard component, a system-wide settings component, or another type of component. Installation of the pack component 856 may include defining relationships, (e.g., source-destination relationships for data) by the pack component 856 and other components (e.g., from other packs) that were previously installed at the worker computer system 824.

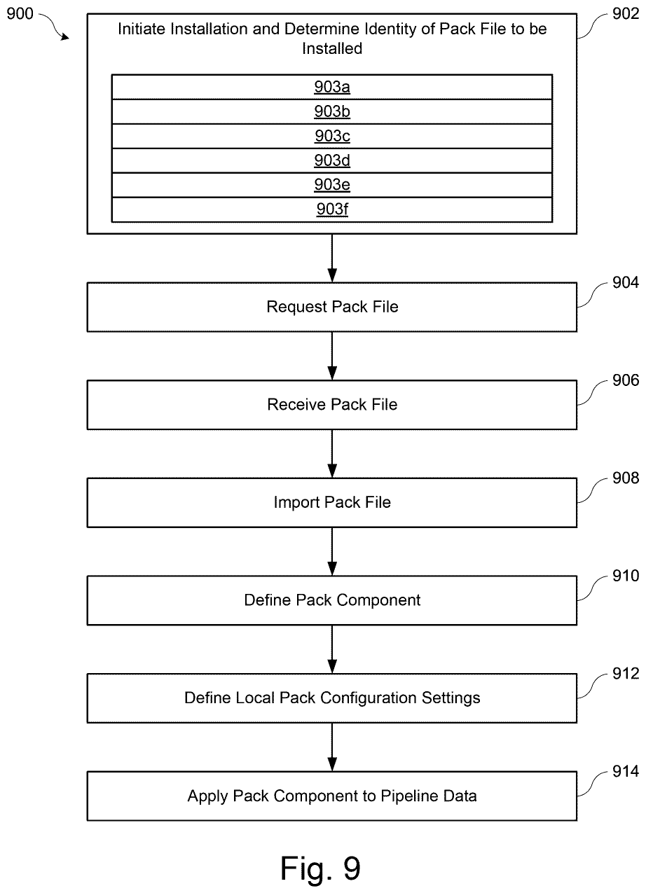

FIG. 9 is a flow diagram showing an example of a process 900 for configuration management in an observability pipeline system, such as the observability pipeline system 810. The process 900 can be used for installing observability pipeline components from a pack file, such as the pack file 612. The description of the configuration management system 600 is relevant to the process 900 and any details regarding the configuration management system 600 may be incorporated in the environment 100.

The process 900 may include additional or different operations, and the operations may be performed in the order shown or in another order. In some cases, operations in the process 900 can be combined, iterated or otherwise repeated, or performed in another manner. The operations of the process 900 may be performed on a computer system. As an example, the process 900 may be performed by one or more computer systems that are associated with the observability pipeline system 110, such as the pack dispensary 610, the leader 622, and/or the workers 624 of the first worker group 620.

In some implementations, the process 900 is implemented in the form of a non-transitory computer-readable storage medium storing instructions operable to cause one or more processors to perform the operations of the process 900. In some implementations, the process 900 is implemented in the form of an apparatus, such as the computer system 500, which includes computer-executable program instructions that are stored by a storage device, such as the memory 520, and one or more processors, such as the processor 510 that are configured to execute the program instructions to cause performance of the operations of the process 900.

Operation 902 includes initiating installation of a pack file, such as the pack file 612. Operation 902 includes determining the identity of the pack file 612 that will be installed, since the pack file 612 may be one of a large number of available packs that may be obtained (e.g., from the pack dispensary 610) and installed at one of the workers 624. As an example, operation 902 may include a determination that the pack file 612 should be installed at one of the workers 624, such as the worker computer system 824. The determination to initiate installation of the pack file 612 may be made at the worker computer system 824, at the leader 622, or at another system. The determination may be made based on a comparison of pack files installed on the leader 622 to the pack files installed on the worker computer system 824, including information regarding the identity and/or version of the installed pack files at each system.

In optional sub-operation 903a, the determination to install the pack file 612 at the worker computer system 824 is made in response to identifying, at the worker computer system 824, that the pack file 612 is installed at the leader 622 and is not installed at the worker computer system 824. As an example, the worker computer system 824 may request information from the leader 622 regarding pack files installed at the leader 622 and compare that information to a list of pack files installed at the worker computer system 824 to make this determination.

In optional sub-operation 903b, the determination to install the pack file 612 at the worker computer system 824 is made in response to identifying, at the worker computer system 824, that a different (e.g., newer) version of the pack file 612 is installed at the leader 622 relative to the version of the pack file 612 that is installed at the worker computer system 824. As an example, the worker computer system 824 may request information from the leader 622 regarding the versions of pack files installed at the leader 622 and compare that information to a list of versions pack files installed at the worker computer system 824 to make this determination.

In optional sub-operation 903c, the determination to install the pack file 612 at the worker computer system 824 is made in response to identifying, at the leader 622, that the pack file 612 is installed at the leader 622 and is not installed at the worker computer system 824. As an example, the leader 622 may request information from the worker computer system 824 regarding pack files installed at the worker computer system 824 and compare that information to a list of pack files installed at the leader 622 to make this determination. The leader 622 may then transmit a command to the worker computer system 824 requesting installation of the pack file 612 by the worker computer system 824.

In optional sub-operation 903d, the determination to install the pack file 612 at the worker computer system 824 is made in response to identifying, at the leader 622, that a different (e.g., newer) version of the pack file 612 is installed at the leader 622 relative to the version of the pack file 612 that is installed at the worker computer system 824. As an example, the leader 622 may request information from the worker computer system 824 regarding the versions of pack files installed at the worker computer system 824 and compare that information to a list of versions pack files installed at the leader 622 to make this determination. The leader 622 may then transmit a command to the worker computer system 824 requesting installation of the pack file 612 by the worker computer system 824.

In optional sub-operation 903e, the determination to install the pack file 612 at the worker computer system 824 is based on identification of a reference at the worker computer system 824 to an installed copy of the pack file 612 at the leader 622. The reference may be, for example, a pack file list that indicates which pack files are to be installed at the worker computer system 824. In one example, the pack file list is a listing of all of the pack files that are installed at the leader 622, thereby allowing the worker computer system 824 to be configured similarly or identically to the leader 622. In another example, a pack file list may be generated by the leader 622 based on information regarding the role and configuration of the worker computer system 824 and transmitted to the worker computer system 824 by the leader 622. Other types of references may be used.

In optional sub-operation 903f, the determination to install the pack file 612 at the worker computer system 824 includes selecting the pack file 612 (e.g., from multiple available pack files) using information describing the worker computer system 824. In one implementation, the information describing the worker computer system 824 may include at least one of an application type, a machine type, or an operating system identifier. The application type refers to a type of application installed at the worker computer system 824, such as a webserver. The machine type is a classification of the class of system used as the worker computer system 824, such as “server”, “laptop”, or “desktop.” The operating system identifier may include the name and version of the operating system installed on the worker computer system 824. Other types of information describing the worker computer system 824 may be used. An example of optional sub-operation 903f includes transmitting information describing the worker computer system 824 to the leader computer system. The pack file 612 is selected by the leader 622 for transmission to the worker computer system 824 based in part on the information describing the worker computer system 824. As an example, the leader 622 may use a lookup table, rules, or another method to identify the pack file 612 using the information describing the worker computer system 824. In this example, receiving the pack file 612 occurs subsequent to transmitting the information describing the worker computer system 824 to the leader 622.

Operation 904 includes requesting, at the worker computer system 824, the pack file 612 that was identified in operation 902 or in one of the sub-operations thereof. The pack file 612 may be requested from another computer system. In an implementation, the worker computer system 824, subsequent to identification of the pack file 612 that is needed for installation in operation 902, transmits a message to the pack dispensary 610 that includes an identification of the pack file 612 and requests transmission of the pack file 612 from the pack dispensary 610 to the respective one of the workers 624.

Operation 906 includes receiving, at the worker computer system 824, the pack file 612. As previously described, the pack file 612 includes the observability pipeline component definitions 714. As an example, the workers 624 may receive the pack file 612 from the pack dispensary 610 over a suitable communications channel, such as a local area network or the Internet.

In operation 906, the pack file 612 may be received from the pack dispensary 610, which is configured to provide copies of the pack file to multiple worker groups that each have a different leader computer system. As an example, the pack dispensary 610 is configured to provide the pack file 612 to the first worker group 620, which is managed by the leader 622 and includes the worker computer system 824, and the pack dispensary 610 is configured to provide copies of the pack file 612 to another that does not include the worker computer system 824, such as the second worker group 630. This allows the pack dispensary 610 to efficiently deploy the pack file 612 and other pack files to any number of workgroups.

In some implementations, the pack file 612 is defined in part by the dependency 716 on the referenced pack file 718, and the referenced pack file 718 includes at least one of the observability pipeline component definitions that are incorporated in the pack file 612 to be imported by the worker computer system 824, such as the referenced observability pipeline component definitions 719.

In some implementations, the pack file 612 further includes the pack configuration definitions 713, the worker computer system 824 obtains the leader configuration 844 from the leader 622, and the pack local configuration settings are defined based on the pack configuration definitions 713 and the leader configuration 844.

Operation 908 includes importing the pack file 612 into the observability pipeline system 810 on the worker computer system 824. Importing the pack file 612 into the observability pipeline system may include making the pack file 612 available to one or more processes of the observability pipeline system 810, such as the pack importer 840. Operation 908 may include initiating installation of the pack file 612 using the pack importer 840.

Operation 910 includes defining the pack component 856 (e.g., one or more pack components) in the observability pipeline system 810 on the worker computer system 824 based on the observability pipeline component definitions 714 from the pack file 612. Operation 910 may be performed by the pack importer 840 as previously described. Operation 912 includes defining the pack local configuration settings 851 for the pack component 856. In one implementation, operation 910, includes modifying at least one of the changeable pack configuration settings 854 based on a local override value, such as one of the user inputs 846, obtained at the worker computer system 824.

Operation 914 includes applying the pack component 856 to pipeline data in the observability pipeline system 810 on the worker computer system 824. As examples, the pack component may be one of a processor component configured to accept the pipeline data and apply a transformation to the pipeline data, a source component configured to define a source connection to a source that provides at least a portion of the pipeline data, a sink component configured to define a destination connection to a destination that accepts at least a portion of the pipeline data, a solution component that contains two or more other sub-components in a self-contained system, a knowledge component that contains knowledge objects, a dashboard component, or a system-wide settings component configured to control settings that affect data processing by the observability pipeline system 810.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A non-transitory computer-readable storage medium storing instructions operable to cause one or more processors to perform operations, the operations comprising:
identifying, at a worker computer system that is managed by a leader computer system, a pack file that is installed at the leader computer system and is not installed at the worker computer system;
requesting, at the worker computer system, the pack file;
receiving, at the worker computer system, the pack file, wherein the pack file includes observability pipeline component definitions;
importing the pack file into an observability pipeline system on the worker computer system;
defining pack components in the observability pipeline system based on the observability pipeline component definitions from the pack file;
defining pack local configuration settings for the pack components; and
applying the pack components to pipeline data in the observability pipeline system.

2. The non-transitory computer-readable storage medium of claim 1, wherein the pack file is received from a pack dispensary that is configured to provide copies of the pack file to a first worker group that includes the worker computer system and is also configured to provide copies of the pack file to a second worker group that does not include the worker computer system.

3. The non-transitory computer-readable storage medium of claim 1, wherein the worker computer system includes a reference to an installed copy of the pack file at the leader computer system.

4. The non-transitory computer-readable storage medium of claim 1, wherein the pack file is defined in part by a dependency on a referenced pack file, and the referenced pack file includes at least one of the observability pipeline component definitions.

5. The non-transitory computer-readable storage medium of claim 1, the operations further comprising:
transmitting information describing the worker computer system to the leader computer system, wherein receiving the pack file occurs subsequent to transmitting the information describing the worker computer system to the leader computer system, and the pack file is selected by the leader computer system for transmission to the worker computer system based in part on the information describing the worker computer system.

6. The non-transitory computer-readable storage medium of claim 5, wherein the information describing the worker computer system includes at least one of an application type, a machine type, or an operating system identifier.

7. The non-transitory computer-readable storage medium of claim 1, wherein the pack file further includes pack configuration definitions, the worker computer system obtains a leader configuration from the leader computer system, and the pack local configuration settings are defined based on the pack configuration definitions and the leader configuration.

8. The non-transitory computer-readable storage medium of claim 1, wherein the pack components include at least one of:
a processor component configured to accept the pipeline data and apply a transformation to the pipeline data,
a source component configured to define a source connection to a source that provides at least a portion of the pipeline data,
a sink component configured to define a destination connection to a destination that accepts at least a portion of the pipeline data,
a solution component that contains two or more other sub-components in a self-contained system,
a knowledge component that contains knowledge objects,
a dashboard component, or
a system-wide settings component.

9. A non-transitory computer-readable storage medium storing instructions operable to cause one or more processors to perform operations, the operations comprising:
requesting, at a worker computer system that is managed by a leader computer system, a pack file based on a reference at the worker computer system to an installed copy of the pack file at the leader computer system;
receiving, at the worker computer system, the pack file, wherein the pack file includes observability pipeline component definitions;
importing the pack file into an observability pipeline system on the worker computer system;
defining pack components in the observability pipeline system based on the observability pipeline component definitions from the pack file;
defining pack local configuration settings for the pack components; and
applying the pack components to pipeline data in the observability pipeline system.

10. The non-transitory computer-readable storage medium of claim 9, wherein the pack file is received from a pack dispensary that is configured to provide copies of the pack file to a first worker group that includes the worker computer system and is also configured to provide copies of the pack file to a second worker group that does not include the worker computer system.

11. The non-transitory computer-readable storage medium of claim 9, wherein the pack file is defined in part by a dependency on a referenced pack file, and the referenced pack file includes at least one of the observability pipeline component definitions.

12. The non-transitory computer-readable storage medium of claim 9, the operations further comprising:
transmitting information describing the worker computer system to the leader computer system, wherein receiving the pack file at the worker computer system occurs subsequent to transmitting the information describing the worker computer system to the leader computer system, and the pack file is selected by the leader computer system for transmission to the worker computer system based in part on the information describing the worker computer system.

13. The non-transitory computer-readable storage medium of claim 12, wherein the information describing the worker computer system includes at least one of an application type, a machine type, or an operating system identifier.

14. The non-transitory computer-readable storage medium of claim 9, wherein the pack file further includes pack configuration definitions, the worker computer system obtains a leader configuration from the leader computer system, and the pack local configuration settings are defined based on the pack configuration definitions and the leader configuration.

15. The non-transitory computer-readable storage medium of claim 9, wherein the pack components include at least one of:
a processor component configured to accept the pipeline data and apply a transformation to the pipeline data,
a source component configured to define a source connection to a source that provides at least a portion of the pipeline data,
a sink component configured to define a destination connection to a destination that accepts at least a portion of the pipeline data,
a solution component that contains two or more other sub-components in a self-contained system,
a knowledge component that contains knowledge objects,
a dashboard component, or
a system-wide settings component.

16. A non-transitory computer-readable storage medium storing instructions operable to cause one or more processors to perform operations, the operations comprising:
requesting, at a worker computer system that is managed by a leader computer system, a pack file;
receiving, at the worker computer system, the pack file, wherein the pack file includes pack configuration definitions and observability pipeline component definitions;
importing the pack file into an observability pipeline system on the worker computer system;
defining pack components in the observability pipeline system based on the observability pipeline component definitions from the pack file;
defining pack local configuration settings for the pack components based on the pack configuration definitions, wherein the pack local configuration settings include fixed pack configuration settings and changeable pack configuration settings;
modifying at least one of the changeable pack configuration settings based on a local override value obtained at the worker computer system; and
applying the pack components to pipeline data in the observability pipeline system.

17. The non-transitory computer-readable storage medium of claim 16, wherein the pack file is received from a pack dispensary that is configured to provide copies of the pack file to a first worker group that includes the worker computer system and is also configured to provide copies of the pack file to a second worker group that does not include the worker computer system.

18. The non-transitory computer-readable storage medium of claim 16, the operations further comprising:
transmitting information describing the worker computer system to the leader computer system, wherein receiving the pack file occurs subsequent to transmitting the information describing the worker computer system to the leader computer system, and the pack file is selected by the leader computer system for transmission to the worker computer system based in part on the information describing the worker computer system.

19. The non-transitory computer-readable storage medium of claim 18, wherein the information describing the worker computer system includes at least one of an application type, a machine type, or an operating system identifier.

20. The non-transitory computer-readable storage medium of claim 16, wherein the pack components include at least one of:
a processor component configured to accept the pipeline data and apply a transformation to the pipeline data,
a source component configured to define a source connection to a source that provides at least a portion of the pipeline data,
a sink component configured to define a destination connection to a destination that accepts at least a portion of the pipeline data,
a solution component that contains two or more other sub-components in a self-contained system,
a knowledge component that contains knowledge objects,
a dashboard component, or
a system-wide settings component.
